(19) United States
(12) Patent Application Publication
(10) Pub. No.: US 2008/0196371 A1
(43) Pub. Date: Aug. 21, 2008

(54) Electrically Driven, Reel-Mower Accessories

(75) Inventors: Christian Stanton Carver Bryant, Charlotte, NC (US); Kenneth R. Wilson, Stanley, NC (US); Martin M. Carlson, Tega Cay, SC (US); Carlos A. Bellot, Charlotte, NC (US); Harry L. Derby, Charlotte, NC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 12/033,425

(22) Filed: Feb. 19, 2008

Related U.S. Application Data
(60) Provisional application No. 60/902,488, filed on Feb. 20, 2007.

(51) Int. Cl. A01D 75/30

(52) U.S. Cl. 56/7

(57) ABSTRACT

Real-mower accessories according to the present teachings are electrically driven. The electrically powered accessories use electric motors that can be operated independently of the transport wheels of the mower. Electrically powered accessories can use the on-board power source of the mower to which it is attached along with the control assembly thereon. The electrically powered accessories enable rotational rates and direction of rotation of the components of the electrically powered accessories to be easily adjusted and changed independently of other components of the mower. The electrically powered accessories can provide a more efficiently powered accessory. The electrically powered accessories can allow a user to independently verify the speed and direction of the electrically powered accessory relative to the other electrically powered accessories or other electrically driven components of the mower.

### CROSS-REFERENCE TO RELATED APPLICATIONS

This application claims the benefit of U.S. Provisional Application No. 60/902,488, filed on Feb. 20, 2007. The disclosure of the above application is incorporated herein by reference.

### FIELD

The present disclosure relates to reel-mower accessories and to electrically driven, reel-mower accessories.

### BACKGROUND

The statements in this section merely provide background information related to the present teachings and may not constitute prior art.

Traditional accessories used on reel-type mowers (both walk-behind and riders) use hydraulically powered accessories. Hydraulic systems, however, can be inefficient and messy. Hydraulic fluid can leak from the systems and harm the turf grass over which the mower is operated. The hydraulic systems can require complex mechanizations to facilitate complex control of the driven accessories. Thus, it would be advantageous to use non-hydraulically powered accessories.

### SUMMARY

Reel-driven turf maintenance accessories according to the present teachings are electrically driven. The electrically powered accessories use electric motors that can be operated independently of the motors that drive the transport wheels of the turf maintenance device to which the electrically powered accessory is attached. The electrically powered accessories can use the on-board power source of the turf maintenance device to which it is attached along with the control assembly thereon. The various reel implements of the accessories can be coupled together with a coupling mechanism thereby enabling the electric motor to drive all of the reel implements of the accessory through the coupling mechanism.

An electrically powered reel-driven mower accessory according the present teachings can include a frame and a first reel implement rotatably coupled to the frame. The first reel implement can perform a turf maintenance procedure when in contact with and rotating relative to a turf surface. A second reel implement can be coupled to the frame. The second reel implement can perform a turf maintenance procedure when in contact with and rotating relative to a turf surface. An electric motor is coupled to the frame and to the first reel implement. The motor drives rotation of the first reel implement relative to the frame in response to an electric current. A coupling mechanism couples the first and second reel implements together such that rotation of said first reel implement drives rotation of the second reel implement through the coupling mechanism.

A turf maintenance device according to the present teachings can include a first frame along with a power source supported by the first frame and operable to supply electric current. A drive wheel is rotatably coupled to the first frame and can move the turf maintenance device over a turf surface. A first electric motor is coupled to the drive wheel and to the power source. The first motor is operable to drive rotation of the drive wheel. An electrically powered accessory can be coupled to the first frame. The electrically powered accessory can include a second frame and a first reel implement rotatably coupled to the second frame. The first reel implement is operable to perform a turf maintenance procedure when in contact with and rotating relative to a turf surface. A second reel implement is coupled to the second frame. The second reel implement is operable to perform a turf maintenance procedure when in contact with and rotating relative to a turf surface. A second electric motor is coupled to the power source, to the second frame and to the first reel implement. The second motor drives rotation of the first reel implement relative to the second frame in response to an electric current from the power source. The second motor is independent of the first motor such that each motor can operate independently of the other. A coupling mechanism couples the first and second reel implements together such that rotation of said first reel implement drives rotation of the second reel implement through the coupling mechanism.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present teachings in any way.

FIG. 1 is a perspective view of an electrically powered, reel-mower accessory on an electrically driven, walk-behind, reel mower according to the present teachings;

FIGS. 2 and 3 are partial assembly views of the electrically powered, reel-mower accessory of FIG. 1;

FIG. 4 is a perspective of another electrically powered, reel-mower accessory according to the present teachings;

FIGS. 5-7 are top, front, and side views, respectively, of the electrically powered, reel-mower accessory of FIG. 4;

FIG. 8 is a schematic view of the drive system used on the electrically powered, reel-mower accessory of FIG. 4;

FIG. 9 is a perspective view of another electrically powered, reel-mower accessory according to the present teachings;

FIGS. 10-12 are top, front and side views, respectively, of the electrically powered, reel-mower accessory of FIG. 9; and

FIG. 13 is a simplified schematic view of an exemplary control system that can be utilized with an electrically powered, reel-mower accessory according to the present teachings.

### DETAILED DESCRIPTION

The following description is merely exemplary in nature and is not intended to limit the present teachings, application, or uses. It should be understood that throughout the drawings, corresponding reference numerals indicate like or corresponding parts and features and are indicated with indices that are indexed by 100 (e.g., 20, 120, 220, etc.). As used herein, the term module refers to an application specific integrated circuit (ASIC), an electronic circuit, a processor (shared, dedicated, or group) and memory that can execute one or more software or firmware programs, a combinational logic circuit, and/or other suitable components that provide the described functionality.

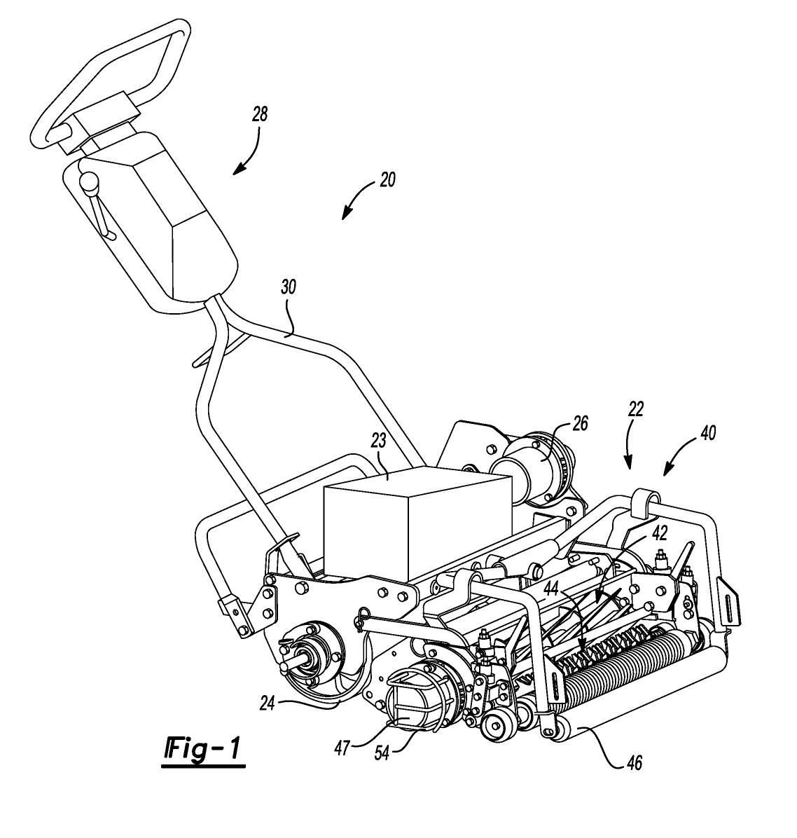

Referring to FIG. 1, an exemplary turf maintenance device 20, to which electrically powered accessories 22 according to the present teachings can be attached, is shown. Turf maintenance device 20 can take a variety of forms. By way of non-limiting example, turf maintenance device 20 can be a walk-behind mower, as shown, a riding mower (not shown), or a standing mower. Hereinafter, turf maintenance device 20 is referred to simply as mower 20. It should be appreciated, however, that the turf maintenance device can take forms other than that of the walk-behind mower 20 depicted.

To power electrically powered accessories 22 according to the present teachings, mower 20 includes an on-board electrical power source 23 suitable for powering electrically powered accessory 22. In some embodiments, power source 23 can supply 48-volt DC electrical power to electrically powered accessories 22. In other embodiments, power source 23 can provide other voltages, which can be DC or AC.

In some embodiments, such as the one shown in FIG. 1, mower 20 can be an entirely electrically driven mower and on-board power source 23 can include one or more batteries or other electrical energy storage devices which power mower 20 and electrically powered accessories 22 attached thereto. The batteries can be rechargeable. In other embodiments, power source 23 can include an internal combustion engine that drives an electrical generator or alternator that can supply electrical power to electrically powered accessories 22 attached to mower 20. In some embodiments, power source 23 can include one or more batteries or other electrical energy storage devices along with an internal combustion engine that drives an electrical generator or alternator that can supply electrical power to mower 20, electrically powered accessories 22 and/or the batteries or other electrical energy storage devices.

Mower 20 includes a traction drive 24, such as a transport wheel, by way of non-limiting example. Traction drive 24 can be electrically driven and can include an electric motor 26 that drives rotation of transport wheel 24 either directly or through a coupled mechanism (not shown), such as a pulley drive system, by way of non-limiting example.

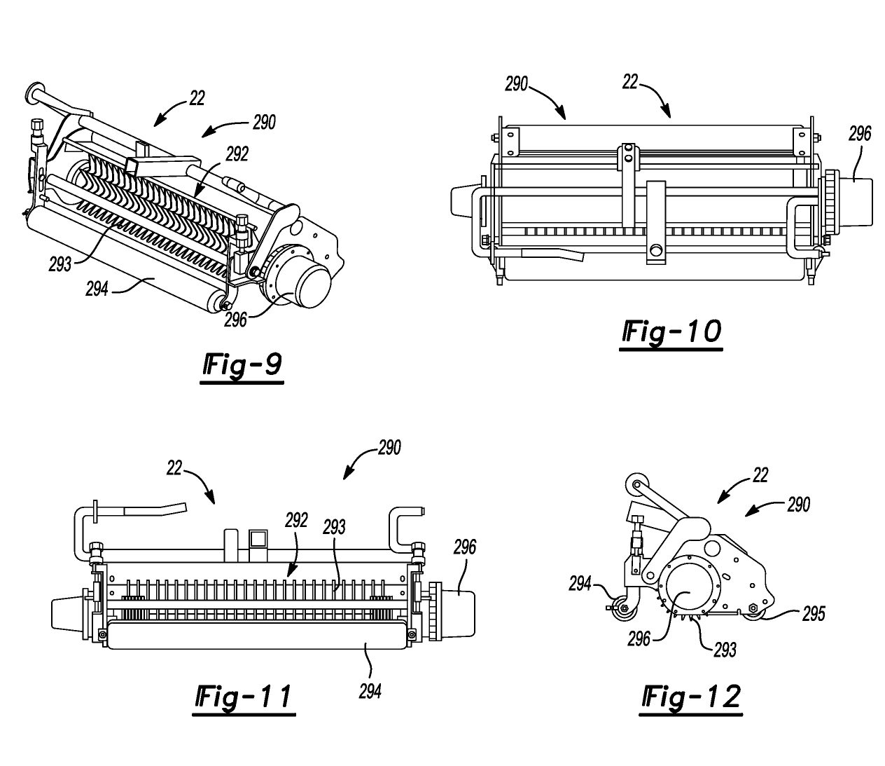

A control assembly 28 is disposed on a handle assembly 30 projecting rearwardly from mower 20. The controls on control assembly 28 allow an operator of mower 20 to control the operation of mower 20 and the electrically powered accessories 22 attached thereto. In some embodiments, the controls on control assembly 28 can include mechanical mechanisms. In some embodiments, such as that shown in FIG. 13, the controls on control assembly 28 can provide signals to a control module 32 that are indicative of a desired operation of mower 20 and/or electrically powered accessories 22. Control module 32 can command operation of traction drive 24 and electrically powered accessories 22 in response to the signals from control assembly 28. In some embodiments, power source 23 can route electrical power to control module 32 which can than provide the electrical power to traction drive 24 and electrically powered accessories 22. In some embodiments, power source 23 can supply electrical power directly to traction drive 24 and electrically powered accessories 22, as shown in dashed lines, which are controlled by control module 32. In some embodiments, control module 32 can be a single control module. In some embodiments, control module 32 can include a plurality of control modules that are separate from and/or integral with one another. In some embodiments, electrically powered accessories 22 can include a control module.

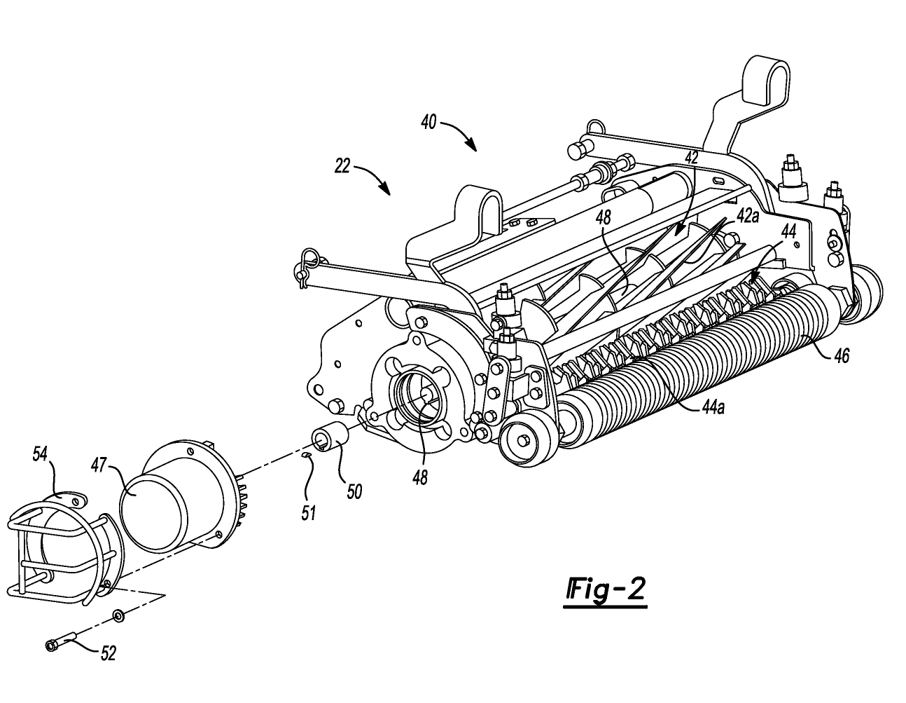

The electrically powered accessory 22 according to the present teachings can take a variety of forms. For example, as shown in FIGS. 1-3, electrically powered accessory 22 is in the form of an electrically powered, reel and groomer accessory 40 (reel/groomer accessory). Reel/groomer accessory 40 can be coupled to mower 20, as shown in FIG. 1. Reel/groomer accessory 40 is electrically powered and runs off the electrical power supplied by power source 23 of mower 20 to which it is attached. Reel/groomer accessory 40 includes a cutting reel 42, a turf groomer 44 and a front roller 46. Cutting reel 42 includes a plurality of conventional spiraled blades 42a equally spaced around the cutting reel drive shaft 48 and which move past a bed knife for the usual and well-known function of grass cutting. Groomer 44 includes a plurality of cutting members 44a for the usual and well-known function of cutting turf grass runners.

The output shaft of an electrical motor 47 is coupled to central drive shaft 48 of cutting reel 42 with a coupler 50 and a key 51. Motor 47 is attached to a side of reel/groomer accessory 40 with bolts 52. A protective cage 54 can surround the portion of motor 47 that extends outwardly from reel/groomer accessory 40.

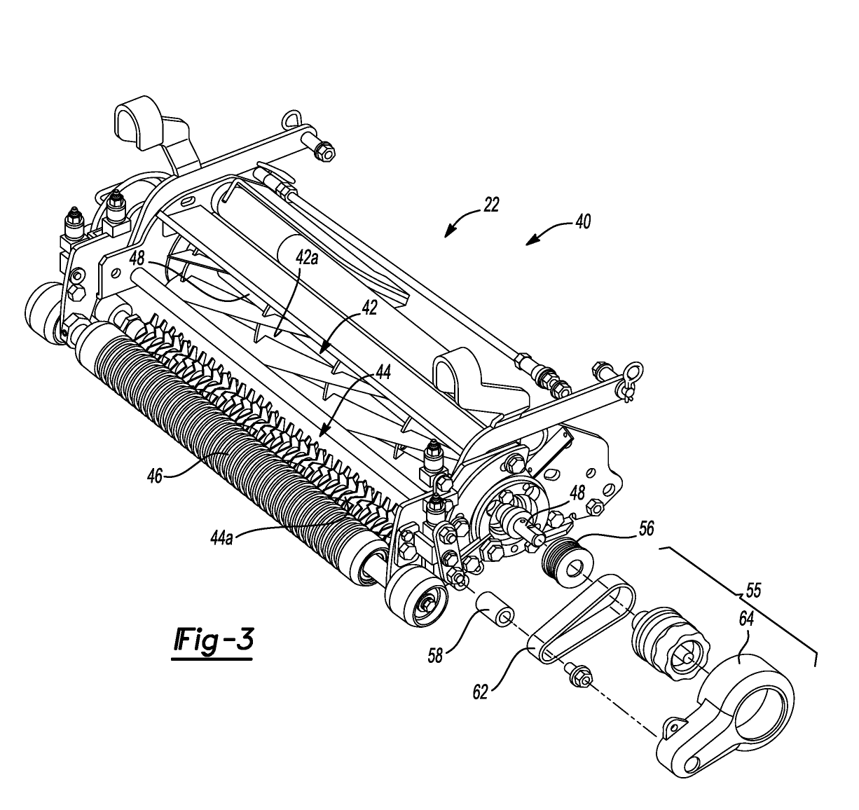

Motor 47 is operable to drive rotation of cutting reel 42 in response to commands from control assembly 28. Motor 47 can also drive rotation of groomer 44 with a coupling mechanism 55. Coupling mechanism 55 can take a variety of forms. For example, coupling mechanism 55 can be a belt-drive system, such as that shown in FIG. 3, a mechanical gear coupling, a chain-drive system, a clutch mechanism, or the like by way of non-limiting example. Thus, it should be appreciated that, while the coupling mechanism 55 shown in FIG. 3 is in the form of a belt-drive system, other coupling mechanisms can be utilized and are within the scope of the present teachings. Coupling mechanism 55, as shown in FIG. 3, is a belt-drive system and includes a drive pulley 56 which can be coupled to an end of drive shaft 48 of cutting reel 42 opposite motor 47. A driven pulley 58 can be coupled to an end of a drive shaft 60 of groomer 44 on a same side of reel/groomer accessory 40 as drive pulley 56. A drive belt 62 can couple drive pulley 56 to driven pulley 58. A cover 64 encloses pulleys 56, 58 and drive belt 62. Rotation of cutting reel 42 thereby drives rotation of groomer 44 through drive belt 62. The rate of rotation of cutting reel 42 and groomer 44 can be the same or different from one another based on the relative sizes of drive pulley 56 and driven pulley 58. Additionally, cutting reel 42 and groomer 44 can be configured to rotate in opposite directions, if desired.

Motor 47 can operate independently of motor 26 driving transport wheel 24 of mower 20 and independently of other accessories on mower 20. As such, the rotational speed of cutting reel 42 and groomer 44 can be different (faster or slower) than or the same as the rotational speed of transport wheel 24. Additionally, the direction of rotation of cutting reel 42 and groomer 44 can be different than or the same as the direction of rotation of transport wheel 24. Moreover, motor 47 can be operated while mower 20 is stationary and not being driven by motor 26. Furthermore, the ability to independently operate motor 47 also allows a user to independently verify the speed and direction of reel/groomer accessory 40 relative to the other electrically powered accessories 22 or other electrically driven components of mower 20.

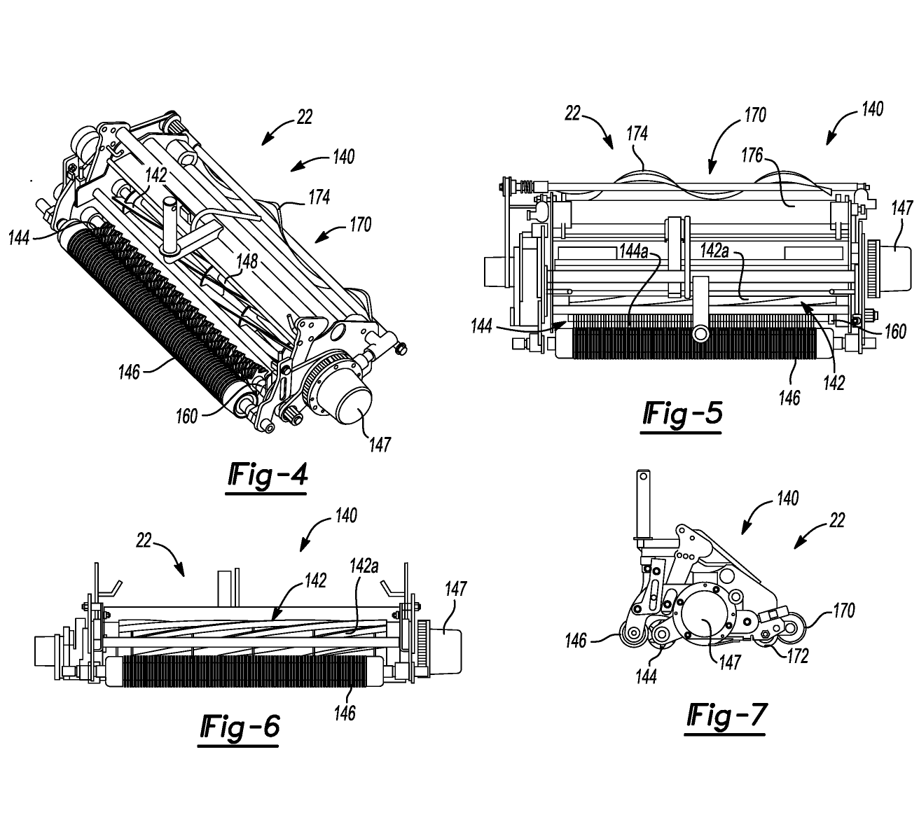

Referring now to FIGS. 4-7, another electrically powered accessory 22 according to the present teachings that can be attached to mower 20 is shown. In the embodiments shown in FIGS. 4-7, electrically powered accessory 22 is in the form of a cutting-reel groomer, power-brush accessory 140 (RGPB accessory). RGPB accessory 140 is similar to reel/groomer accessory 40 discussed above with the addition of a rear power brush 170 and a rear roller 172. As such, RGPB accessory 140 includes a cutting reel 142, a turf groomer 144 and a front roller 146. Cutting reel 142 includes a plurality of conventional spiraled blades 142a equally spaced around the cutting reel drive shaft 148 and which move past a bed knife for the usual and well-known function of grass cutting. Groomer 144 includes a plurality of cutting members 144a for the usual and well-known function of cutting turf grass runners.

The output shaft of an electrical motor 147 is coupled to the central drive shaft 148 of cutting reel 142 for driving rotation of cutting reel 142. Motor 147 is attached to a side of RGPB accessory 140. RGPB accessory 140 is electrically powered and runs off power provided by power source 23 on mower 20 to which it is attached.

Power brush 170 includes a spiraled brush member 174 around a central shaft 176. Brush member 174 rotates with rotation of central shaft 176. Brush member 174 wipes (brushes) against rear roller 172 to conventionally remove grass clippings from and clean rear roller 172.

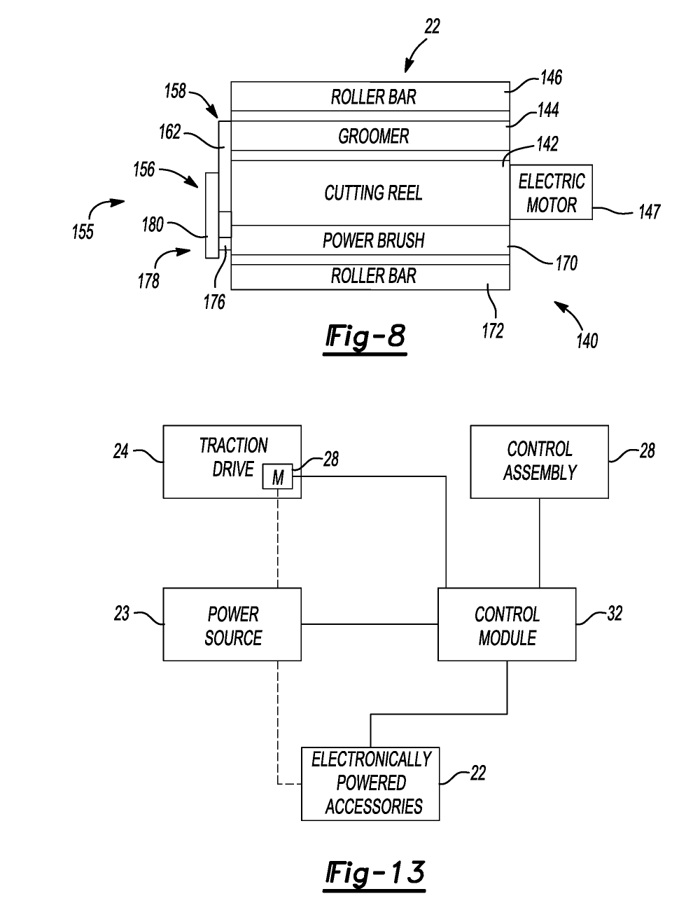

Referring to FIG. 8, motor 147 is operable to drive rotation of cutting reel 142 in response to commands from the control assembly 28 on the mower 20 to which RGPB accessory 140 is attached. Motor 147 also drives rotation of groomer 144 and power brush 170. A coupling mechanism 155 can couple the various components of RGPB accessory 140 to one another to enable these components to be driven by the rotation of cutting reel 142. In the embodiment shown in FIG. 8, coupling mechanism 155 is a pulley drive system and includes a double-drive pulley 156 which can be coupled to an end of drive shaft 148 of cutting reel 142 opposite motor 147. A first driven pulley 158 can be coupled to an end of a drive shaft 160 of groomer 144 on a same side of RGPB accessory 140 as drive pulley 156. A first drive belt 162 can couple drive pulley 156 to first driven pulley 158. A second driven pulley 178 can be coupled to an end of central shaft 176 of power brush 170 on a same side of RGPB accessory 140 as drive pulley 156. A second drive belt 180 can couple drive pulley 156 to second driven pulley 178. Rotation of cutting reel 142 can thereby drive rotation of groomer 144 through first drive belt 162 and rotation of power brush 170 through second drive belt 180. The rate of rotation of cutting reel 142, groomer 144, and power brush 170 can be the same or different from one another based on the relative sizes of drive pulley 156 and driven pulleys 158, 178.

Motor 147 can operate independently of motor 26 driving the transport wheel 24 of mower 20 to which RGPB accessory 140 is attached. As such, the rotational speed of cutting reel 142, groomer 144 and power brush 170 can be different (faster or slower) than or the same as the rotational speed of transport wheel 24. Additionally, the direction of rotation of cutting reel 142, groomer 144 and power brush 170 can be different than or the same as the direction of rotation of transport wheel 24. Moreover, motor 147 can be operated while mower 20 is stationary and not being driven by motor 26. Furthermore, the ability to independently operate motor 147 also allows a user to independently verify the speed and direction of RGPB accessory 140 relative to the other electrically powered accessories 22 or other electrically driven components of mower 20.

Referring now to FIGS. 9-12, another electrically powered accessory 22 according to the present teachings is shown. In these figures, electrically powered accessory 22 is a vertical cutting accessory 290. Vertical cutting accessory 290 includes a vertical cutting head 292 having a plurality of vertically extending cutting blades 293 that are fixed on a central shaft. Cutting blades 293 rotate with rotation of the central shaft and conventionally perform the usual and well-known function of removing thatch and pulling up turf grass runners below the soil surface. Vertical cutting accessory 290 includes a front roller 294 and a rear roller 295 that roll along the turf being cut by vertical cutting head 292. Front and rear rollers 294, 295 can adjust the position of vertical cutting head 292 relative to the turf.

Vertical cutting accessory 290 includes an electric motor 296 coupled to the side of vertical cutting accessory 290 and whose output shaft is coupled to the central shaft of vertical cutting head 292. Motor 296 can be directly coupled to the central shaft of vertical cutting head 292 or indirectly though a coupling mechanism, such as intermeshing gears, a belt-and-pulley system, or a chain drive system, by way of non-limiting example. Motor 296 is operable to drive rotation of vertical cutting head 292 in response to commands from the control assembly 28 on mower 20. Motor 296 is electrically powered and runs off the electrical power supplied by power source 23 on mower 20 to which it is attached. One skilled in the art will recognize that the various embodiments of FIGS. 9-12 may include and be configured to operate one or both of the groomer and/or striping brush described above.

Motor 296 can operate independently of motor 26 driving transport wheel 24 of mower 20 and independently of other accessories on mower 20. As such, the rotational speed of vertical cutting head 292 can be different (faster or slower) than or the same as the rotational speed of transport wheel 24. Additionally, the direction of rotation of vertical cutting head 292 can be different than or the same as the direction of rotation of transport wheel 24. Moreover, motor 290 can be operated while mower 20 is stationary and not being driven by motor 26. Furthermore, the ability to independently operate motor 290 also allows a user to independently verify the speed and direction of vertical cutting accessory 290 relative to the other electrically powered accessories 22 or other electrically driven components of mower 20.

The use of electrically powered accessories 22 can advantageously avoid the use of hydraulic motors and associated components and the potential mess and environmental impact of leaking hydraulic fluid. Additionally, the use of electrically powered accessories 22 enables the rotational rates and direction of rotation of the components of electrically powered accessories 22 to be easily adjusted and changed independently of other components of mower 20. Furthermore, the use of electrically powered accessories 22 can provide a more efficient powered accessory. Moreover, when a mower 20 utilizes a plurality electrically powered accessories 22 at the same time, the operation of each electrically powered accessory 22 can be independently controlled. It should be appreciated that the electric motors used on electrically powered accessories 22 can be DC motors, can be bidirectional motors, and can be of varying speeds and power. By way of non-limiting example, the motors can be ¾ to 1½ horsepower DC motors.

While the electrically powered accessories 22 according to the present teachings have been described with reference to specific examples and configurations. It should be appreciated that changes in these configurations can be employed without deviating from the spirit and scope of the present teachings. For example, a plurality of independently operable motors can be used to independently drive the various rotating components of electrically powered accessories 22. Such independent drives would advantageously allow the rates and direction of rotation of the independently driven components to be easily and dynamically changed relative to one another during operation of the electrically powered accessory 22. Additionally, while belt-and-pulley systems are illustrated for coupling the rotation of one component to another component in electrically powered accessories 22, other motion coupling systems, such as intermeshing gears, chain drives, clutch mechanisms and the like can be used by way of non-limiting example.

1. An electrically powered reel-driven mower accessory comprising:
a frame;
a first reel implement rotatably coupled to the frame, the first reel implement operable to perform a turf maintenance procedure when in contact with and rotating relative to a turf surface;
a second reel implement coupled to the frame, the second reel implement operable to perform a turf maintenance procedure when in contact with and rotating relative to a turf surface;
an electric motor coupled to the frame and to the first reel implement, the motor driving rotation of the first reel implement relative to the frame in response to an electric current; and
a coupling mechanism coupling the first and second reel implements together such that rotation of said first reel implement drives rotation of the second reel implement through the coupling mechanism.

2. The electrically powered reel-driven mower accessory of claim 1, wherein the first reel implement includes a shaft rotatably coupled to the frame and the electric motor is coupled to the shaft.

3. The electrically powered reel-driven mower accessory of claim 2, wherein the electric motor has an output shaft that is aligned with and coupled to the first reel implement shaft with a coupler.

4. The electrically powered reel-driven mower accessory of claim 2, wherein the motor is coupled to a first end of the shaft and the coupling mechanism couples a second end of the shaft to the second reel implement.

5. The electrically powered reel-driven mower accessory of claim 4, wherein the coupling mechanism includes at least one pulley and a belt.

6. The electrically powered reel-driven mower accessory of claim 4, wherein the second reel implement includes a shaft rotatably coupled to the frame and the coupling mechanism includes a first pulley coupled to the first reel implement shaft, a second pulley coupled to the second reel implement shaft and a belt extending between the first and second pulleys such that rotation of the first reel implement shaft by the electric motor drives rotation of the second reel implement shaft through the belt.

7. The electrically powered reel-driven mower accessory of claim 1, further comprising at least one roller coupled to the frame, the at least one roller having a shaft rotatably coupled to the frame, and the at least one roller rotating relative to the frame independently of the first and second reel implements.

8. The electrically powered reel-driven mower accessory of claim 1, wherein the first reel implement is a cutting reel and the second reel implement is a turf groomer.

9. The electrically powered reel-driven mower accessory of claim 1, further comprising a third reel implement rotatably coupled to the frame, the third reel implement operable to perform a turf maintenance procedure, and wherein the coupling mechanism couples the third reel implement to the first reel implement such that rotation of the first reel implement drives rotation of the third reel implement through the coupling mechanism.

10. The electrically powered reel-driven mower accessory of claim 9, wherein a pulley is coupled to each reel implement and a first belt extends between the first reel implement pulley and the second reel implement pulley and a second belt extends between the first reel implement pulley and the third reel implement pulley.

11. The electrically powered reel-driven mower accessory of claim 9, wherein the first reel implement is a cutting reel, the second reel implement is a turf groomer, and the third reel implement is a power brush.

12. A turf maintenance device comprising:
a first frame;
a power source support by the first frame and operable to supply electric current;
a drive wheel rotatably coupled to the first frame and operable to move the turf maintenance device over a turf surface;
a first electric motor coupled to the drive wheel and the power source, the first electric motor operable to drive rotation of the drive wheel;
an electrically powered accessory coupled to the first frame, the electrically powered accessory including:
a second frame;
a first reel implement rotatably coupled to the second frame, the first reel implement operable to perform a turf maintenance procedure when in contact with and rotating relative to a turf surface;
a second reel implement coupled to the second frame, the second reel implement operable to perform a turf maintenance procedure when in contact with and rotating relative to a turf surface;
a second electric motor coupled to the power source, the second frame and the first reel implement, the second motor driving rotation of the first reel implement relative to the second frame in response to an electric current from the power source, the second motor being independent of the first motor such that each motor can operate independently of the other; and
a coupling mechanism coupling the first and second reel implements together such that rotation of said first reel implement drives rotation of the second reel implement through the coupling mechanism.

13. The turf maintenance device of claim 12, wherein the first reel implement includes a shaft rotatably coupled to the second frame and the second motor is coupled to the shaft.

14. The turf maintenance device of claim 13, wherein the second motor has an output shaft that is aligned with and coupled to the first reel implement shaft with a coupler.

15. The turf maintenance device of claim 13, wherein the second motor is coupled to a first end of the shaft and the coupling mechanism couples a second end of the shaft to the second reel implement.

16. The turf maintenance device of claim 15, wherein the coupling mechanism includes at least one pulley and a belt.

17. The turf maintenance device of claim 15, wherein the second reel implement includes a shaft rotatably coupled to the second frame and the coupling mechanism includes a first pulley coupled to the first reel implement shaft, a second pulley coupled to the second reel implement shaft and a belt extending between the first and second pulleys such that rotation of the first reel implement shaft by the second motor drives rotation of the second reel implement shaft through the belt.

18. The turf maintenance device of claim 12, further comprising at least one roller coupled to the second frame, the at least one roller having a shaft rotatably coupled to the second frame, and the at least one roller rotating relative to the second frame independently of the first and second reel implements.

19. The turf maintenance device of claim 12, wherein the first reel implement is a cutting reel and the second reel implement is a turf groomer.

20. The turf maintenance device of claim 12, further comprising a third reel implement rotatably coupled to the second frame, the third reel implement operable to perform a turf maintenance procedure, and wherein the coupling mechanism couples the third reel implement to the first reel implement such that rotation of the first reel implement drives rotation of the third reel implement through the coupling mechanism.

21. The turf maintenance device of claim 20, wherein a pulley is coupled to each reel implement and a first belt extends between the first reel implement pulley and the second reel implement pulley and a second belt extends between the first reel implement pulley and the third reel implement pulley.

22. The turf maintenance device of claim 20, wherein the first reel implement is a cutting reel, the second reel implement is a turf groomer, and the third reel implement is a power brush.
